(19) United States
(12) Patent Application Publication
(10) Pub. No.: US 2013/0044362 A1
(43) Pub. Date: Feb. 21, 2013

(54) OPTICAL DEVICE

(71) Applicants: Lawrence George Commander, Tilehurst (GB); Brian William Holmes, Fleet (GB)

(72) Inventors: Lawrence George Commander, Tilehurst (GB); Brian William Holmes, Fleet (GB)

(73) Assignee: DE LA RUE INTERNATIONAL LIMITED, Basingstoke, Hampshire (GB)

(21) Appl. No.: 13/582,539

(22) PCT Filed: Mar. 1, 2011
(86) PCT No.: PCT/GB11/50409

§ 371 Date: Oct. 18, 2012

(30) Foreign Application Priority Data
Mar. 1, 2010 (GB) 1003398.3

(51) Int. Cl. G02B 26/00

(52) U.S. Cl. 359/291

(57) ABSTRACT

An optical device comprises a transparent substrate having: an array of micromirrors on one surface of the substrate; and a corresponding array of microimage elements, the micromirrors presenting convex surfaces to the microimage elements whereby each convex surface causes ambient light to pass through the microimage element array from a virtual focus, the arrangement of the microimage elements and micromirrors being such that they cooperate to generate a lenticular type or a moiré magnification effect.

The invention relates to an optical device, such as a security device for use on articles of value such as banknotes, cheques, passports, identity cards, certificates of authenticity, fiscal stamps and other documents for securing value or personal identity. It also relates to optical devices for use on packaging and the like.

Many different optical security devices are known of which the most common are holograms and other diffractive devices which are often found on credit cards and the like, It is also known to use micro-optics to provide security devices such as moiré magnifiers as, for example, described in EP-A-1695121 and WO-A-94/27254. It is also known to provide lenticular devices as security devices, for example as described in U.S. Pat. No. 4,892,336. Other examples of optical devices can be found in US-A-2003-0179364, WO-A-2009/085004, US-A-2008/0160226 and WO-A-2010/113114 (only published on 7 Oct. 2010).

Both lenticular and moiré magnifier devices are constrained in thickness by the minimum dimension of the microimage elements that can be achieved. This is because the focusing elements of the devices have to focus on the microimage elements and have the same or substantially the same pitch as the microimage elements. Thus, the microimage element pitch sets a minimum focusing element dimension, such as a lens diameter, and this in turn sets a minimum focal length. This is explained in more detail in WO-A-2005/106601.

It is known that moiré magnification effects can be achieved without lenses, by creating an array of bright spots illuminating the repeating structures. This can be created simply by printing a mask and laying it over the microimage array. Similarly, a lenticular device structure can be “decoded” by placing a mask over the image elements which blocks all the parts or strips of the image elements except the one which is desired to be viewed. These constructions are very simple to construct but the images seen are dark since the mask absorbs most of the light. An example of this structure can be found in WO-A-2009/085004.

In accordance with the present invention, an optical device comprises:
(i) an array of micromirrors on one surface of the substrate; and
(ii) a corresponding array of microimage elements, the micromirrors presenting convex surfaces to the microimage elements whereby each convex surface causes ambient light to pass through the microimage element array from a virtual focus, the arrangement of the microimage elements and micromirrors being such that they cooperate to generate a lenticular type or a moiré magnification effect.

An array of convex micromirrors will create an array of bright spots since each micromirror creates a virtual image of the ambient lighting. Each bright spot is formed below the micromirror (at a virtual focus). Since the micromirror is not focusing on the microimage elements, it does not constrain the thickness of the device with respect to the pitch of the micromirrors or the size of the microimage elements. Additionally, the physical separation of the bright spots and the microimage elements determines the amount of parallax which is observed when the device is tilted. Furthermore, since the bright spot is not constrained to be within the thickness of the device (because it is virtual), it is possible to have a thin device with relatively coarse image elements, for example conventional print, and still achieve reasonable movement. Typically, the microimages and micromirrors are provided on two layers, optionally separated by a transparent layer, for example opposite surfaces of a substrate. It is possible to have the two layers in intimate contact, i.e. the microimage elements are in direct contact with the micromirrors and thus the thickness of the device is limited to be only as thick as the thickness of the two layers. This is particularly advantageous in the case of a security thread or an applied patch.

As explained above, the optical security device can be fabricated as a moiré magnifier or a lenticular type device. In the latter case, each microimage element comprises a combination of different sub-elements, corresponding sub-elements of each image element cooperating to define a respective view of a lenticular image. In addition, it should be noted that for convenience we refer to a ‘lenticular type’ device even though no lenses are involved.

In the former case, the microimage elements are typically substantially identical, the pitch of the microimage elements being different from the pitch of the micromirrors so that a moiré magnified image is generated.

Typically, the micromirrors will be fully reflective although it is possible that devices could be constructed with partially reflective mirrors allowing underlying information or colours and the like to be viewed therethrough.

For a device operating as a moiré magnifier the microimage elements typically comprise microprint with sizes in the range 1-1000 microns and preferably 10-500 microns, and even more preferably 100-300 microns, and may be black in colour If other colours are chosen then these give a more visible effect if they are strong/dense enough to effectively mask the light.

The microimage elements could be printed on the substrate or directly onto the micromirrors, for example by gravure printing, lithographic printing, screen printing, intaglio printing or flexographic printing, inkjet, laserjet, or nano-imprint lithography. Alternatively, they could be formed wholly or partially as a relief structure using, for example, embossing or cast-curing rather than conventional printing. Of the two non-print processes mentioned, cast-curing provides higher fidelity of replication.

A variety of different relief structures can be used as will described in more detail below. However, the microimages could simply be created by embossing/cast-curing the images as diffraction grating areas. Differing parts of the image could be differentiated by the use of differing pitches or different orientations of grating. Alternative (and/or additional differentiating) image structures are anti-reflection structures such as moth-eye (see for example WO-A-2005/106601), zero-order diffraction structures, stepped surface relief optical structures known as Aztec structures (see for example WO-A-2005/115119) or simple scattering structures. For most applications, these structures could be partially metallised or HRI coated to enhance brightness and contrast.

In a lenticular type device, an integral number of microimage strips will be provided under each micromirror. The width of each strip is dependent on the type of device. Typically, the width of each microimage strip is less than 200 microns, preferably less than 100 microns, most preferably in the range 5-100 microns.

In many cases, the relief microimages will be uninked, typically when in the form of gratings and the like. However, it is also possible to incorporate ink either by filling recesses of the relief structure or onto raised features of the relief structure. Relief structures could, for example, be created by cast-curing or embossing and then the recesses or pits filled by a liquid ink, the excess being removed by a doctor blade or the like. The ink could be a gravure type or ink jet type ink.

In the case of raised areas, these could be inked by methods analogous to offset litho printing or flexographic printing. The inking of raised areas has the advantage that it is better suited to multiple colours since the doctoring process would inevitably mix different inked areas. Multiple colours allow different coloured elements to pass by each other in a movement type design. Particularly attractive is to use a wet litho process to ink the raised areas since this would allow some simple colour based effects (e.g. image flip or a simple moiré effect of moving lines produced by a pitch of colours that doesn't quite match the lens pitch) with the higher resolution raised image effects.

In the case of inking the raised areas the height of the raised area must be greater than the thickness of ink applied to prevent the ink entering the adjacent non-raised regions.

Typical thicknesses of security devices according to the invention are 2-100 microns, more preferably 20-50 microns with mirror heights of 1-50 microns, more preferably 5-25 microns, The periodicity and therefore maximum base diameter for the micromirrors is preferably in the range 5-1000 μm, more preferably 10-500 μm.

The microimage/micromirror combination can form a security device by itself but could also be used in conjunction with other security features such as holograms, diffraction gratings etc.

The micro mirrors are preferably formed by embossing into a substrate surface, an embossable coating on a substrate, cast-curing or the like.

The invention has particular value in protecting flexible substrates such as paper and in particular banknotes, where the device could define a patch, strip or thread. The thickness of the device will be influenced by how its employed within the banknote though to both avoid deformation of paper ream shape during the banknote printing process and furthermore the form and flexibility of the banknote itself, it is desirable that the thickness of the device does not exceed half of the thickness of the banknote itself (typically 85-120 um)
therefore it anticipated that in any embodiment the optical device will be less than 50 um including securing adhesives and preferably substantially so.

For example as a patch applied to a banknote the desired thickness will range from a few microns (excluding securing adhesive) to a maximum of 35-40 um (again excluding adhesive) for a label. Whilst for the case of a strip, the thickness will range again from a few micrometers for the case of a hot-stamped or transferred strip, up to 35-40 um for the case of a non transferred strip wherein the supporting carrier layer is retained (again excluding securing adhesives) as would be necessary should the strip be applied over a mechanical aperture in the banknote substrate.

In the case of a windowed security thread the security device would typically have a final thickness in the range 20-50 μm. Thicker versions of the security device (up to 300 μm) could be employed in applications which include passport paper pages, plastic passport covers, visas, identity cards, brand identification labels, anti-tamper labels—any visually authenticable items.

Furthermore, the device could be provided in a transparent window of a security document to enable it to be viewed in transmission.

Typically, the substrate is a paper or a polymer such as one of polyethylene teraphthalate (PET), polyamide, polycarbonate, polyvinylchloride (PVC), polyvinylidenechloride (PVdC), polymethylmethacrylate (PMMA), polyethylene naphthalate (PEN), and polypropylene.

Some examples of optical security devices according to the invention will now be described with reference to the accompanying drawings, in which:

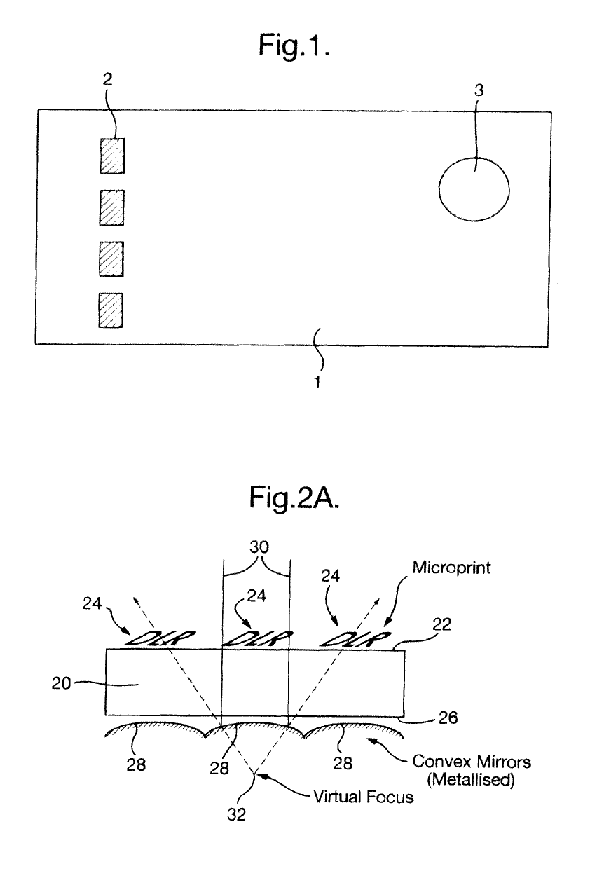

FIG. 1 illustrates schematically a banknote carrying a security device;

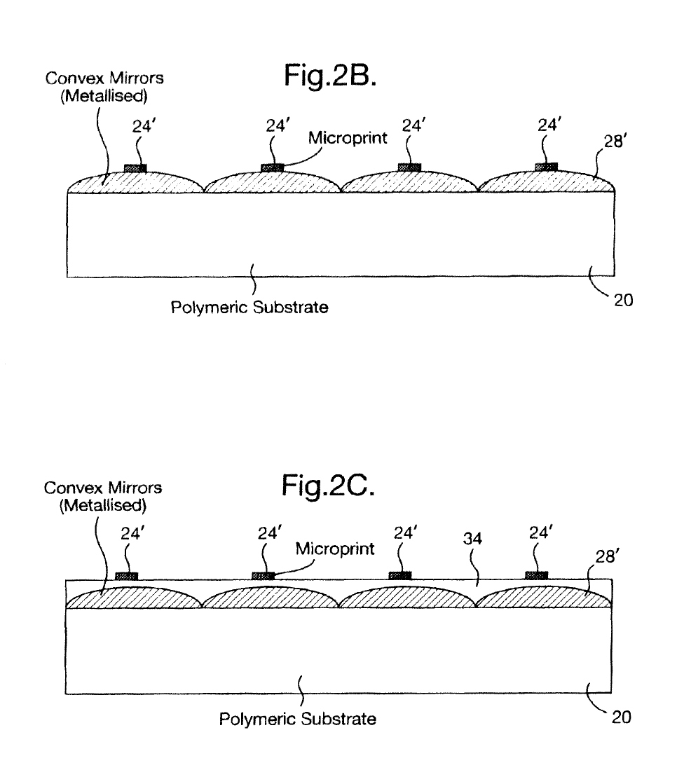

FIG. 2 is a schematic cross-section through a moiré magnifier version of the security device;

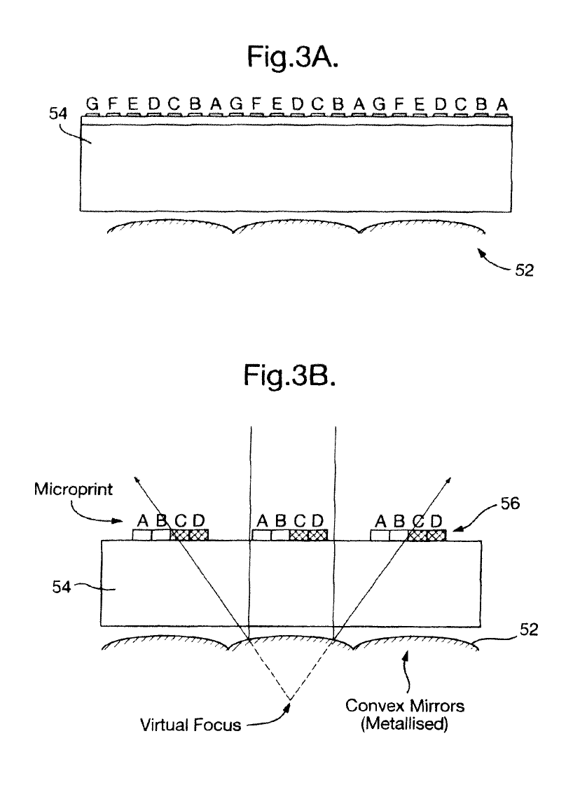

FIG. 3 is a schematic cross-section through a lenticular version of the security device;

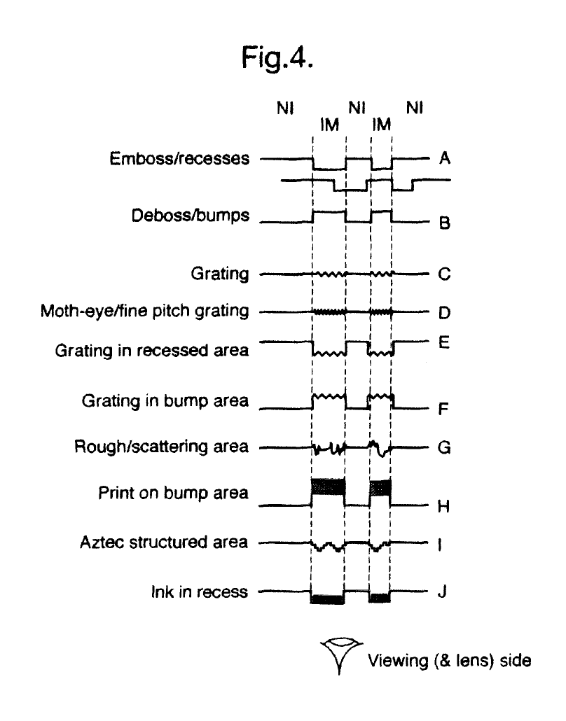

FIGS. 4A to 4J illustrate different types of relief microimages;

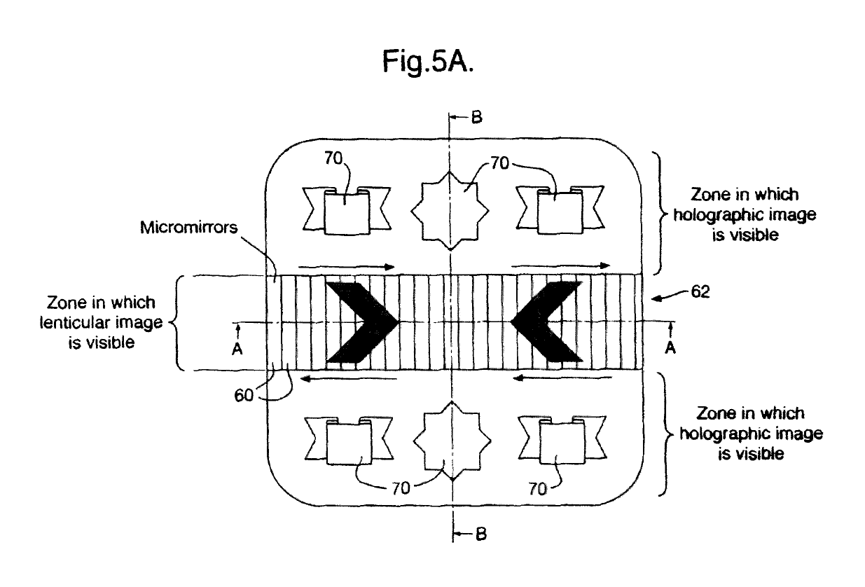

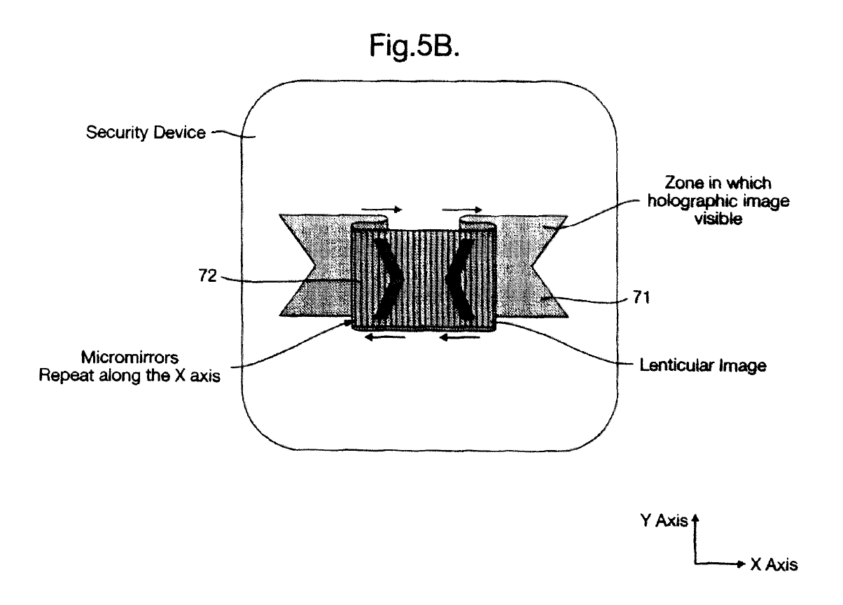

FIG. 5 is a cross-section through a double sided version;

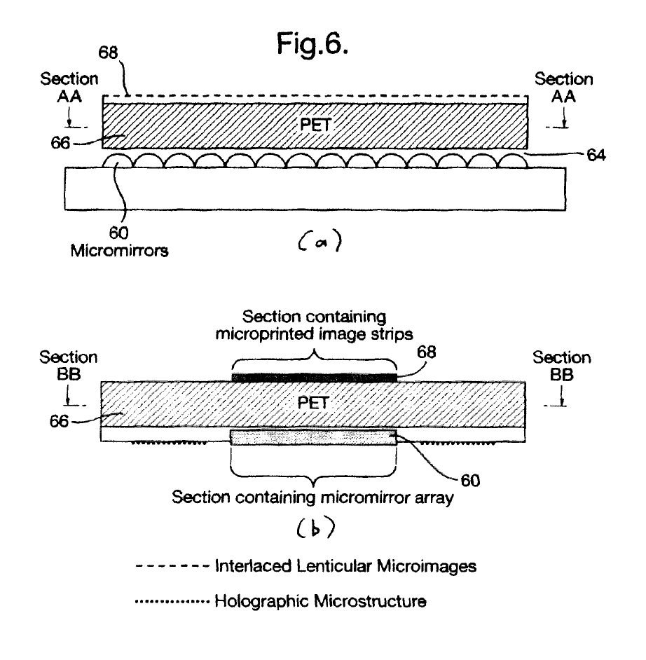

FIGS. 6a and 6b are sections on the lines A-A and B-B in FIG. 5 respectively;

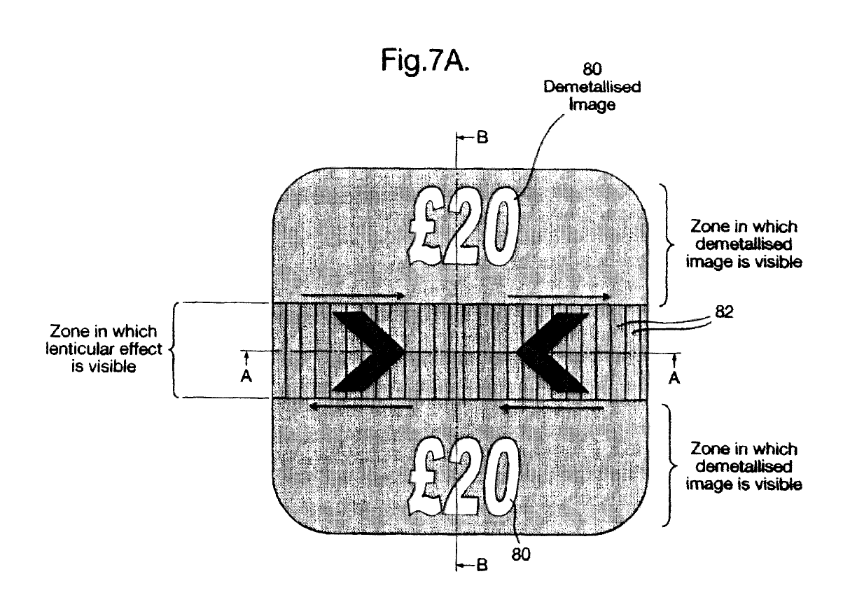

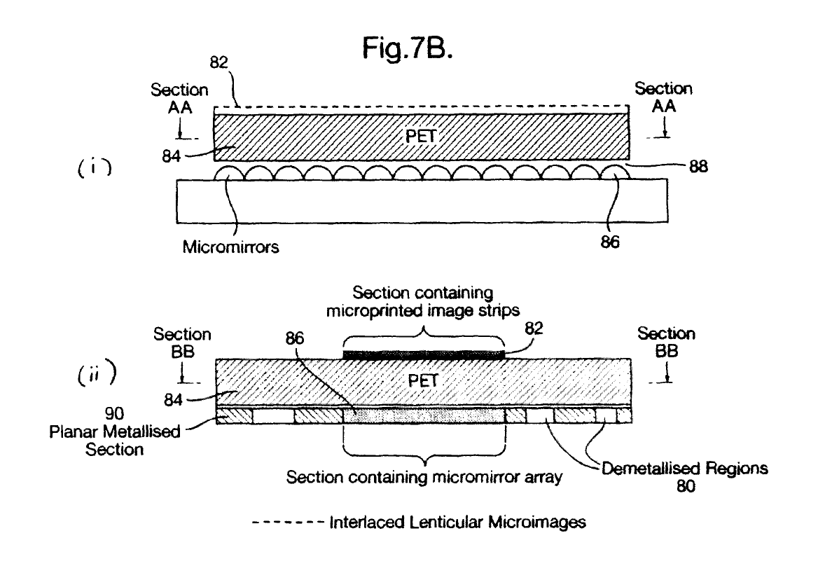

FIG. 7a is a plan view of a further example of a security device according to the invention provided in addition with a demetallised image;

FIGS. 7b(i) and 7b(ii) are sections on the lines A-A and B-B respectively in FIG. 7a;

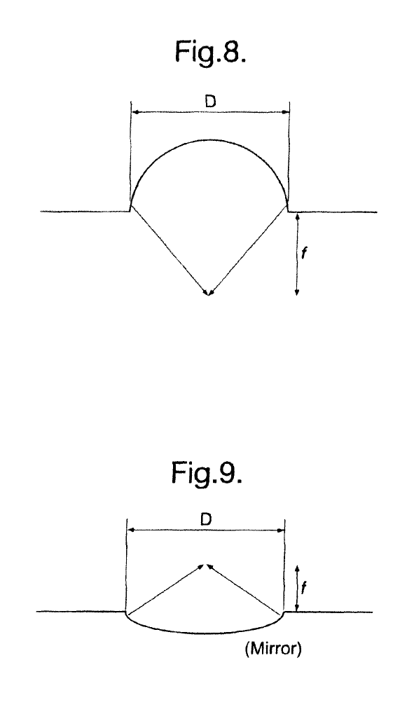

FIG. 8 illustrates dimensions of a concave lens;

FIG. 9 illustrates the dimensions of a concave mirror;

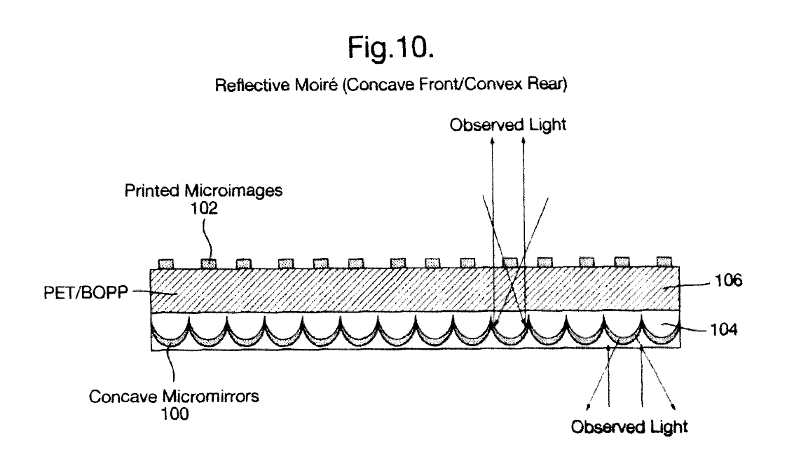

FIG. 10 is a section through an example of a security device not in accordance with the present invention; and,

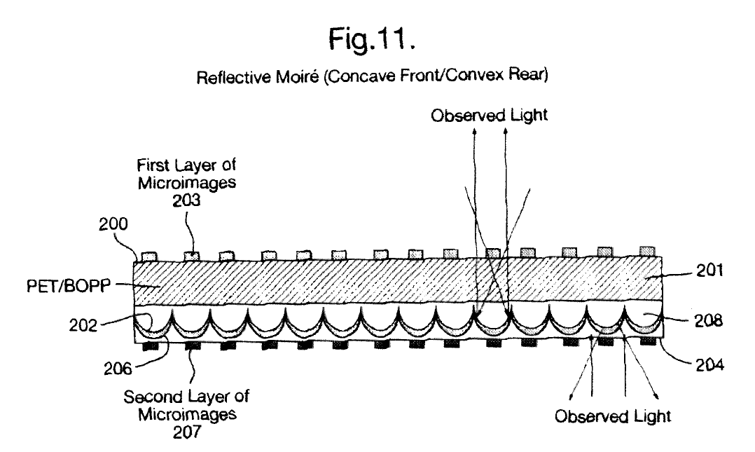

FIG. 11 is a view similar to FIG. 10 but of a further example according to the invention.

FIG. 1 illustrates schematically a banknote 1 having a security thread 2 exposed at windows and a further transparent window 3. The banknote 1 may be made of paper or polymer (such as bi-axially oriented polypropylene) and one or both of the security thread 2 and window 3 incorporates a security device according to the invention.

A first example of a security device according to the invention is shown in FIG. 2a. The transparent, polymer substrate 20 will typically be PET or BOPP and have a thickness in the range 2-100 microns, preferably 20-50 microns, most preferably 5-25 microns.

On an upper surface 22 of the substrate 20 are printed a set (typically 100 or more) of identical microimage elements 24 spaced apart at a first pitch typically in the range 5-1000 microns, preferably 10-500 microns and most preferably 100-300 microns. In this case, the image elements comprise microprint alphanumeric characters.

On the opposite surface 26 of the substrate 20 is provided a corresponding array of embossed or cast-cured convex spherical micromirrors 28 (in reality hemispherical mirrors) which have been metallised so that they are fully reflective. The periodicity of the micromirrors 28 is substantially the same as that of the microprint 24 except that there is a very small mismatch so that moiré magnification will occur. Thus, in order to create the phenomena of moiré magnification and enable the generation of moving images a pitch mismatch is introduced between the microimage array and the micromirror array. One method is to have a micromirror and microimage array with substantially the some pitch where the pitch mismatch is achieved by introducing a small rotational misalignment between the microimage and micromirror array. The degree of rotational misalignment between the microimage and micromirror array is preferably in the range 15°-0.05°, which results in a magnification range of between ˜4×-1000× for the microimage array. More preferably the rotational misalignment is in the range 2°-0.1°, which results in a magnification range of between ˜25×-500× for the microimage array.

Alternatively the microimage array and micromirror array are in substantially perfect rotational alignment but with a small pitch mismatch. A small pitch mismatch would equate to a percentage increase/decrease of the pitch of the microimage array relative to the microlens array in the range 25%-0.1%, which results in a magnification range of between ˜4×-1000× for the microimage array. More preferably the percentage increase/decrease of the pitch of the microimage array relative to the microlens array is in the range 4%-0.2%, which results in a magnification range of between ˜25×-500× for the microimage array.

It is also possible to use a combination of a small pitch mismatch and a small rotational misalignment to create the phenomena of moiré magnification and enable the generation of moving images.

When the device is exposed to ambient light which will effectively be collimated as shown at 30, each mirror 28 will reflect the incoming light in such a way that it appears to come from a virtual focus 32 defining a bright spot which than illuminates the image elements 24 resulting in the generation of moiré magnified images which may appear to move as the device is tilted. The degree of magnification achieved is defined by well known algorithms. As an example, if the micromirror pitch is “a” and the pitch between image elements of an array is “b” then the moiré magnification (M) is given by the formula:

M=1/(1−(b/a))

The apparent depth of the resultant image is given by the separation of the microimage and the virtual focii multiplied by the moiré magnification (M).

It will be noted that the physical separation of the bright spot 32 and the microprint 24 will determine the amount of parallax which is provided by the device.

Although in this and other examples the micromirrors and microimages are provided on surfaces of a single substrate body 20, the substrate could be formed of more than one layer.

The microimage elements in a moiré magnifier device can be printed in a single colour or can be printed in multiple colours. For example in the case of the microimage “DLR” the D, L and R could all be printed in different colours or the colour of the microimage could vary across the microimage array such that the colour of the magnified image will vary as the device is tilted.

The moiré magnifier device of the current invention may contain more than one microimage array in cooperation with the same array of micromirrors thus generating two or more magnified images. The application of moiré magnifiers with two or more microimage arrays as security devices is known from WO-A-2005106601. In relation to the plane of the security device the magnified images resulting from the different microimage arrays can appear at the same apparent depth or different apparent depths. As described previously the apparent depth of the magnified images is controlled by ratio of the pitch of the micromirror array to the pitch of the microimage array.

Moiré magnifiers generated by the current invention can be either 2-dimensional (2D) or 1-dimensional (1D) structures. 2D moiré magnification structures using spherical lenses are described in more detail in EP-A-1695121 and WO-A-94/27254. The example described above utilising spherical micromirrors results in a 2D moiré magnification structure. In a 2D moiré magnifier the microimages are magnified in all directions. In a 10 moiré magnification structure the spherical micromirrors are replaced with a repeating arrangement of cylindrical micromirrors. The result of this is that the microimage elements are subject to moiré magnification in one axis only which is the axis along which the mirrors exhibit their periodic variations in curvature or relief. Consequently the microimages are strongly compressed or de-magnified along the magnification axis whilst the size or dimension of the micro image elements along the axis orthogonal to the magnification axis is substantially the same as they appear to the observer—i.e. no magnification or enlargement takes place.

FIG. 2b shows a further device construction. The upper surface of the polymeric substrate 20 is provided with a corresponding array of embossed or cast-cured micromirrors 28′ on top of a metallised surface of which are printed a set (typically 100 or more) of identical microimage elements 24′. As with the example in FIG. 2a the micromirrors present convex surfaces to the microimage elements and the phenomena of moiré magnification will occur in the same manner as that described for FIG. 2a. An optional spacer layer 34 can be provided on the micromirrors to present a planar surface more suitable for printing on than the convex mirror surface, as shown in FIG. 2

FIG. 3a illustrates a second example, in this case of a ‘lenticular device’ to create an optical effect similar to that observed in conventional lenticular devices. FIG. 3 shows a cross-section through the “lenticular device” which is being used to view images A-G. An array of micromirrors 52 with the same shape and profile as a lenticular lens array is arranged on a transparent substrate 54. Each image is segmented into a number of strips or microimage elements, for example 7 strips, and above each micromirror 52 of the lenticular array, there is a set of image strips corresponding to a particular segmented region of images A-G. Over the first micromirror the strips will each correspond to the first segment of images A-G and under the next micromirror the strips will each correspond to the second segment of images A-G and so forth. Each micromirror 52 is arranged such that only one strip can be viewed from one viewing position through each micromirror 52. At any viewing angle, only the strips corresponding to one of the images (A,B,C et) will be seen through the corresponding mirrors. Thus, each strip of image D will be seen from straight on whereas on tilting a few degrees off-axis the strips from images C or E will be seen.

The strips are arranged as slices of an image, i.e. the strips A are all slices from one image, similarly for B. C et As a result, as the device is tilted a series of images will be seen. The images could be related or unrelated. The simplest device would have two images that would flip between each other as the device is tilted. Alternatively, the images could be a series of images that are shifted laterally strip to strip so that the image appears to move and thus give rise to parallax depth. Similarly, the change from image to image could give rise to animations (parts of the image change in a quasi-continuous fashion), morphing (one image transforms in small steps to another image) or zooming (an image gets larger or smaller in steps). These more sophisticated effects require more images and thus more strips.

In a typical case, the pitch of the micromirrors is about 250 microns and the thickness of the device (substrate and micromirrors) about 30 microns.

The width of each microimage strip will be dependent on the type of optical effect required. For example if the diameter of the micromirrors is 250 μm then a simple switch effect between two views A and B could be achieved using 125 μm wide image strips. Alternatively for a smooth animation effect it is preferable to have as many views as possible typically at least three but ideally as many as 30, and in this case the width of the image strips (and associated bumps or recesses) should be in the range 8-80 μm.

Since the bright spot is not constrained to be within the thickness of the device (because it is virtual), it is possible to have a thin device with relatively coarse image elements and therefore multicoloured conventional printing can be used to form the image strips. FIG. 3b illustrates an example lenticular type device comprising four image strips A-D 56 which are different views of the same image in order to create a lenticular animation effect. In the example shown in FIG. 3b image strips A and B are printed with one colour and image strips C and D are printed with a second colour. In this manner when the device is tilted to create the lenticular animation effect the image will also be seen to change colour as the observer moves from view B to view In a different example all of the strips A-D in one region of the device would be one colour and then all a different colour in a second region of the device. Alternatively image strips A,B,C and D could all be different colours. In a further embodiment image strips A could represent a multicoloured version of one view of the image and image strips C-D could each represent a differently coloured multi-coloured version of the same image

In all cases, the microprint 24, 56 is preferably simply printed onto the surface of the substrate but it is possible to provide the image elements as relief structures as shown in FIG. 4, In each case, the relief structures define the image areas (labelled “IM”) whereas the non-image areas (labelled “NI”) are shown as flat.

FIG. 4A illustrates embossed or recessed image elements. FIG. 4B illustrates debossed image elements. FIG. 4C illustrates image elements in the form of grating structures while FIG. 4D illustrates moth-eye or other fine pitch grating structures.

These structures can be combined. For example, FIG. 4E illustrates image elements formed by gratings in recesses areas while FIG. 4F illustrates gratings on debossed areas.

FIG. 4G illustrates the use of a rough embossing.

FIG. 4H illustrates the provision of print on an embossed area while FIG. 4I illustrates “Aztec” shaped structures.

FIG. 4J illustrates ink filled recesses.

In particularly preferred examples, the security device also includes one or more other optical security features. An example of this is shown in FIGS. 5 and 6. In this example, a device exhibiting a lenticular type effect is formed by a sequence of hemispherical micromirrors 60 with a similar shape and profile as a cylindrical lenticular lens located in a line 62 extending centrally across the security device, which in this case is a label. The micromirrors 60 are embossed or cast-cured into a resin or polymer layer 64 and are formed on a substrate or transparent polymeric spacer layer 66 on which is also provided microimages 68 which are printed in register with the micromirrors. The polymeric layer 66 is a supporting or substrate layer made of a transparent polymer such as biaxial PET or biaxial polypropylene.

In addition to the device exhibiting a lenticular type effect shown in FIGS. 5 and 6, the security device includes a number of holographic image generating structures 70. In the example shown the holographic image structures are cast or embossed into the same resin as the micromirrors 60 but equally two different resins, one suitable for casting the micromirrors and one suitable for embossing a holographic structure could be applied in register. Alternatively the holographic structures could be embossed into a polymeric lacquer positioned on the opposite side of the polymeric layer to the micromirrors.

The image strips associated with the lenticular type effect are arranged so as to give the appearance of moving chevron images as the device is tilted about the axis B-B in FIG. 5A. This provides a primary security effect due to the observed animation. In addition to this, however, the holographic generating structures cause the generation of holographic images which exhibit strong attractive and distinctive colour changes.

The holographic generating structures 70 can be in the form of holograms or DOVID image elements. In the label construction shown in FIG. 5A, the micromirrors and the associated animation is located in a central horizontal band or region of the label whilst the holographic generating structures 70 are located on either side. However, it should be understood that this example is purely illustrative and for example the holographic generating structures could be located in a central band or strip and the lenticular type effect being provided in one or more regions on either side. Alternatively the image provided by the micromirrors and the image provided by the holographic generating structures could be integrated into a single image by each providing components of a single image. FIG. 5b illustrates an example of such an integrated design where the holographic generating structures 71 form a scroll and in the middle of the scroll the holographic structures are replaced with the printed microimages 72 to create a strong lenticular type animation effect in this case of moving chevrons in the middle of the scroll.

In the examples in FIG. 5 it should be appreciated that the animation occurs only when the security device is tilted around an axis which is perpendicular to the direction the micromirrors exhibit their periodic variations in curvature. In this case the animation of the chevrons will occur along the line A-A when the device is tilted around the line B-B.

Conversely if the micromirror system and associated image strips are rotated by 90 degrees then the animation occurs only when the security device is tilted around the line A-A. The animation itself can take place in any direction and is purely dependent on the artwork.

The lenticular type effect formed by a sequence of micromirrors in FIGS. 5 and 6 can be replaced with a moiré magnifier device similar to that illustrated in FIG. 2.

In the case of the holographic structures 70, these can have any conventional form and can be fully or partially metallised. Alternatively the reflection enhancing metallised layer can be replaced with a substantially transparent inorganic high refractive index layer.

Whatever arrangement is defined, it is advantageous if the individual regions allocated to the two different optical effects in FIGS. 5 and 6 are sufficiently large to facilitate clear visualisation of the effects.

The security devices shown in FIGS. 2-6 are suitable to be applied as labels which will typically require the application of a heat or pressure sensitive adhesive to the outer surface close to the micromirrors compared to the microimage elements or strips. In addition an optional protective coating/varnish could be applied to the outer surface containing the microimages or strips. The function of the protective coating/varnish is to increase the durability of the device during transfer onto the security substrate and in circulation.

In the case of a transfer element rather than a label the security device is preferably prefabricated on a carrier substrate and transferred to the substrate in a subsequent working step. The security device can be applied to the document using an adhesive layer. The adhesive layer is applied either to the security device or the surface of the secure document to which the device is to be applied. After transfer the carrier strip can be removed leaving the security device as the exposed layer or alternatively the carrier layer can remain as part of the structure acting as an outer protective layer. A suitable method for transferring security devices based on cast cure devices comprising micro-optical structures is described in EP1897700.

The security device of the current invention can also be incorporated as a security strip or thread. Security threads are now present in many of the world's currencies as well as vouchers, passports, travellers' cheques and other documents. In many cases the thread is provided in a partially embedded or windowed fashion where the thread appears to weave in and out of the paper. One method for producing paper with so-called windowed threads can be found in EP0059056. EP0860298 and WO03095188 describe different approaches for the embedding of wider partially exposed threads into a paper substrate. Wide threads, typically with a width of 2-6 mm, are particularly useful as the additional exposed area allows for better use of optically variable devices such as the current invention. The device structures shown in FIGS. 2-6 could be used as a thread by the application of a layer of transparent colourless adhesive to the outer surfaces of the device.

The security device of the current invention can be made machine readable by the introduction of detectable materials in any of the layers or by the introduction of separate machine-readable layers. Detectable materials that react to an external stimulus include but are not limited to fluorescent, phosphorescent, infrared absorbing, thermochromic, photochromic, magnetic, electrochromic, conductive and piezochromic materials.

Additional optically variable materials can be included in the security device such as thin film interference elements, liquid crystal material and photonic crystal materials. Such materials may be in the form of filmic layers or as pigmented materials suitable for application by printing.

FIGS. 7a, 7b(i) and 7b(ii) shows a second security feature in the form of a demetallised image 80 incorporated within a security device of the current invention. The printed image strips 82 associated with the micromirror structure are arranged so as to give the appearance of moving chevron images as the device is tilted about the axis B-B in FIG. 7a. This provides a primary security effect due to the strong lenticular type animation. As can be seen in FIGS. 7b(i) and 7b(ii), the structure of the feature shown in FIG. 7a comprises a polymeric carrier layer 84 on the lower surface of which is provided a cylindrical micromirror array 86. This will have been formed by cast curing the cylindrical structures into a resin layer 88 and then metallising the structures to form the micromirrors. In this example the metallised layer is extended outside the horizontal band comprising the micromirrors such that the planar surface 90 of the polymeric carrier is also metallised. As can be seen in the section along B-B of FIG. 7b, parts of the metal layer are demetallised to define the demetallised images 80 thus enabling the creation of demetallised indicia which can be viewed in reflective but more preferably transmitted light.

One way to produce partially metallised/demetallised films in which no metal is present in controlled and clearly defined areas, is to selectively demetallise regions using a resist and etch technique such as is described in US-B-4652015. Other techniques for achieving similar effects are for example aluminium can be vacuum deposited through a mask, or aluminium can be selectively removed from a composite strip of a plastic carrier and aluminium using an excimer laser. The metallic regions may be alternatively provided by printing a metal effect ink having a metallic appearance such as Metalstar® inks sold by Eckart.

The presence of a metallic layer can be used to conceal the presence of a machine readable dark magnetic layer. When a magnetic material is incorporated into the device the magnetic material can be applied in any design but common examples include the use of magnetic tramlines or the use of magnetic blocks to form a coded structure. Suitable magnetic materials include iron oxide pigments (Fe₂O₃ or Fe₃O₄), barium or strontium ferrites, iron, nickel, cobalt and alloys of these. In this context the term “alloy” includes materials such as Nickel:Cobalt, Iron:Aluminium:Nickel:Cobalt and the like. Flake Nickel materials can be used; in addition Iron flake materials are suitable. Typical nickel flakes have lateral dimensions in the range 5-50 microns and a thickness less than 2 microns. Typical iron flakes have lateral dimensions in the range 10-30 microns and a thickness less than 2 microns.

In an alternative machine-readable embodiment a transparent magnetic layer can be incorporated at any position within the device structure. Suitable transparent magnetic layers containing a distribution of particles of a magnetic material of a size and distributed in a concentration at which the magnetic layer remains transparent are described in WO03091953 and WO03091952.

In a further example the security device of the current invention may be incorporated in a security document such that the device is incorporated in a transparent region of the document. The security document may have a substrate formed from any conventional material including paper and polymer. Techniques are known in the art for forming transparent regions in each of these types of substrate. For example, WO8300659 describes a polymer banknote formed from a transparent substrate comprising an opacifying coating on both sides of the substrate. The opacifying coating is omitted in localised regions on both sides of the substrate to form a transparent region.

EP1141480 describes a method of making a transparent region in a paper substrate. Other methods for forming transparent regions in paper substrates are described in EP0723501, EP0724519, EP1398174 and WO03054297.

A further emdodiment, particularly suitable for incorporating in a transparent region of a secure document, is to use both sides of the micromirrors to generate a device exhibiting a different optically variable effect from either side, A convex mirror is a concave mirror when viewed from the reverse when a thin metal layer is used to form the mirror. Thus, it is possible to have a device with concave mirrors with microimages on the other side of the above described device with convex mirrors. The use of concave mirrors as focussing elements in moiré magnifiers and devices generating lenticular effects provides some advantages over the use of conventional lenses as will be described.

The back focal length of a lens, f, is (to a 1^{st} approximation) restricted to being no shorter than the diameter, D (see FIG. 8).

Or mathematically:

f≧D

Fundamentally, the limit is driven by the amount of deflection achievable by refraction according to Snell's law. The deflection possible is determined by the topology of the lens and refractive indices of the material(s). The lens topology determines what angle the edge of lens makes to the surface. The refraction imparted is determined the surface angle plus the refractive index difference between the lens and the air in front of it.

With a mirror, the deflection angle is not determined by Snell's law but by the law of reflection (angle of reflection equals angle of incidence). This is much more powerful than refraction—a curved mirror which at its edge forms an angle of 45° to the surface will deflect the light by 90° overall, i.e. parallel to the surface (FIG. 9).

For the mirrored surface: f≧0

There are other benefits:
The height (or depth) of mirror surface itself will be less for a given focal length
Because the mirror is metallised, both the mirror and images can be overcoated with adhesive

The fact that the focal length (and hence thickness) is not restricted by the diameter of the micromirror means that a moiré magnifier or lenticular type device can have a thickness which is independent of the minimum printable line width. Thus, in practice, it is possible to combine conventional litho printing (200 um high characters) with concave micromirror to make a moiré magnifier or lenticular type device with a 30 um thickness.

FIG. 10 illustrates a typical cross-section of a security device not according to the invention based on the combination of an array of spherical concave micromirrors 100 with an array of printed microimages 102 to create a moiré magnifier. In this example a series of micromirrors 100 are formed in thermoforming resin 104 by casting a set of spherical microlenses and then vapour depositing a layer of metal on the back surface. A printed microimage array 102 is formed on the top surface of the device substrate 106. The periodicity of the spherical micromirrors is substantially the same as that of the microimages except that there is a very small mismatch so that moiré magnification will occur.

FIG. 11 illustrates a dual sided moiré magnifier structure which on one side 200 (preferably the front side of the device) of a transport substrate 201 presents the synthetic image generated by a concave mirror reflective moiré 202 and microimages 203 and on the rear side 204 it presents a moiré magnified image presented by a convex micromirror system 206 and a second layer of microimages 207 In the schematic representation of FIG. 11, a transparent layer of resin 208 is provided between the convex reflectors 206 and print 207—though in certain situations this layer 208 could be omitted and print directly onto the convex mirrors. If present, the layer 208 could be provided with a dye or colorant such that the back image has a different reflective hue to the front. Clearly the images presented front and back will be determined by the printed image arrays present on the front and rear surface, which can differ in image composition and or colour. As well as 20 moiré we can also have 1D moiré front and rear or 1D moiré on front and lenticular image on the back.

The dual-sided device as shown in FIG. 11 can also be combined with additional security features as described with reference to the single-sided embodiments.

All or part of the printed microimage arrays or microimage strips may be printed with inks comprising materials that respond visibly to invisible radiation. Luminescent materials are known to those skilled in the art to include materials having fluorescent or phosphorescent properties. It is also well known to use other materials that respond visibly to invisible radiation such as photochromic materials and thermochromic materials, Referring to the example in FIG. 2 all of the microprint DLR could be printed in an ink that is invisible under normal lighting conditions but visible under UV illumination, in this case the magnified image will only be observed under UV illumination. Alternatively the microprint “DLR” could be printed in an ink that changes colour on exposure to UV radiation such that a change in colour of the magnified image is observed under UV radiation. Alternatively the microprint “DLR” could be printed such that it, and the resultant magnified image, appears all in one colour under normal lighting conditions but appears in different colours under UV illumination. Examples of printing materials which enable this type of effect are described in WO2004050376A1.

Inks with different metameric properties could also be employed in the current invention. Examples of metameric inks are provided in GB1407065. Referring again to FIG. 2 the “D” could be printed in a first metameric ink and the “L” and “R” printed in a second metameric ink where the metameric properties of the inks are such that they appear to be of an identical colour when viewed in daylight, but when viewed in filtered light, the two inks will appear to have different reflective colours. In this case the magnified image will appear differently in daylight to when viewed using a metameric filter.

If the moiré magnifier device of the current invention contains more than one microimage array then one or more of the different microimages may be printed with inks comprising materials that respond visibly to invisible radiation or metameric inks as described above. For example only one of the magnified images might be visible in normal daylight conditions with the second magnified image becoming visible only under UV illumination. Alternatively the two magnified image arrays could appear the same colour in normal daylight conditions and different colours when viewed using a filter or when viewed under UV illumination.

1. An optical device comprising a transparent substrate having:
(i) an array of micromirrors on one surface of the substrate; and
(ii) a corresponding array of microimage elements, the micromirrors presenting convex surfaces to the microimage elements whereby each convex surface causes ambient light to pass through the microimage element array from a virtual focus, the arrangement of the microimage elements and micromirrors being such that they cooperate to generate a lenticular type or a moiré magnification effect.

2. A device according to claim 1, wherein each microimage element comprises a combination of different sub-elements, corresponding sub-elements of each image element cooperating to define a respective view of a lenticular image.

3. A device according to claim 2, wherein some of the sub-elements are formed in one or more colours different from other sub-elements.

4. A device according to claim 1, wherein the microimage elements are substantially identical, the pitch of the image elements being mismatched with the pitch of the micromirrors so that a moiré magnified image is generated.

5. A device according to claim 1, wherein the array of micromirrors is provided on an opposite surface of the substrate to the microimage elements.

6. A device according to claim 1, wherein the array of microimage elements is provided on the convex surfaces of the micromirrors.

7. A device according to claim 1, wherein the micromirrors are fully reflective,

8. A device according to claim 1, wherein the minimum lateral dimension of the micromirrors is in the range 1-500 microns.

9. A device according to a claim 1, wherein the microimage elements are provided in one or more partially transparent, non-black colours.

10. A device according to claim 1, wherein the microimage elements comprise icons such as symbols, geometric figures, alphanumeric characters, logos and pictorial representations.

11. A device according to claim 1, wherein the microimage elements are printed on the substrate of the device.

12. A device according to claim 1, wherein the microimage elements are formed as grating structures, recesses or other relief patterns on the substrate.

13. A device according to claim 1, wherein the substrate comprises a polymer such as one of polyethylene teraphthalate (PET), polyamide, polycarbonate, polyvinylchloride (PVC), polyvinylidenechloride (PVdC), polymethylmethacrylate (PMMA), polyethylene naphthalate (PEN), and polypropylene.

14. A device according to claim 1, wherein the distance from the array of micromirrors to the array of microimage elements is in the range 2-100 microns.

15. A device according to claim 1, wherein the micromirrors also present concave micromirrors on the opposite side to the convex mirrors, and further comprising a second array of microimages facing the concave micromirrors, the second array of microimages co-operating with the concave micromirrors to generate a lenticular type or a moiré magnification effect.

16. A security device according to claim 1.

17. A device according to claim 16, formed of a security thread, label or patch.

18. A security device according to claim 16, the device being provided in a transparent window of a security document such as a banknote, identification card or the like.

19. An article provided with an optical device according to claim 1.

20. An article according to claim 19, wherein the article comprises one of banknotes, cheques, passports, identity cards, certificates of authenticity, fiscal stamps and other documents for securing value or personal identity.
